(19) United States
(12) Patent Application Publication
(10) Pub. No.: US 2008/0113674 A1
(43) Pub. Date: May 15, 2008

(54) Vicinity-based community for wireless users

(76) Inventor: Mohammad Faisal Baig, Secaucus, NJ (US)

Correspondence Address: ABELMAN, FRAYNE & SCHWAB, 666 THIRD AVENUE, 10TH FLOOR, NEW YORK, NY, 10017, US

(21) Appl. No.: 11/982,005

(22) Filed: Oct. 31, 2007

Related U.S. Application Data
(60) Provisional application No. 60/858,204, filed on Nov. 10, 2006.

(51) Int. Cl. H04Q 7/20

(52) U.S. Cl. 455/456.3

(57) ABSTRACT

A method and apparatus for providing vicinity-based community services at a wireless access location by a public network service provider. The method includes the steps of receiving over a public network, at least one request for vicinity-based community services from at least one end-user accessing the wireless access point, grouping end-users accessing common wireless access points, and providing the vicinity-based community services in real time to end-users accessing the public network service provider from the wireless access point. The apparatus includes devices for carrying out the method described above.

### CROSS REFERENCE TO RELATED APPLICATION

This patent application claims the benefit of U.S. Provisional Application Ser. No. 60/858,204, filed Nov. 10, 2006, the content of which is incorporated by reference herein in its entirety.

### FIELD OF THE INVENTION

The present invention relates generally to vicinity-based communications services, and more specifically to an apparatus and method for providing various services for mobile devices which are in communication with local area network wireless access points.

### BACKGROUND OF THE INVENTION

Wireless “hotspots” are locations with wireless connectivity where users having mobile devices, such as laptops, PDA, mobile phones and the like, can connect to a public network (e.g., the Internet) using standard WiFi technology (often referred to as Wireless LAN or WLAN technology). Other wireless technologies which enable wireless connectivity can include WiMax, among other wireless technology standards.

A WiFi hotspot is enabled by a wireless device known as an “access point” (AP), which emits a wireless signal in a limited geographical area, and connects mobile devices to the public network. Generally, one AP can communicate with several dozen client systems located within a radius of one hundred meters (100 m), although this distance may vary greatly based upon the type of wireless equipment or specific standards in use. Further, several access points can be implemented at a hotspot to increase the available of user service. The range of wireless communications between the mobile devices and an access point can vary, depending on topographical variables such as placement of the AP, elevation, nearby obstructions, and the like.

Although conventional wireless hotspots provide users of wireless mobile devices, e.g. laptops, with access to the Internet, specific services directed at WiFi users at a wireless hotspot are currently not available. For example, while users at a hotspot can access the Internet and chat with other users on the Internet and form communities, there is no such service available which allows users at a hotspot to form a real-time community only with users present at that hotspot based upon the sharing of a common wireless access point, thus ensuring a community of users in vicinity to one another who can then participate in various action such as bartering of items, advertising related services, among other community-related services.

### SUMMARY OF THE INVENTION

The present invention provides a vicinity-based community for wireless users at a hotspot as described herein. In particular, the present invention includes a method and apparatus for providing a vicinity-based community at a wireless access location, such as a hotspot. The method includes the steps of receiving over a public network at least one request for vicinity-based community services from at least one end-user accessing the wireless access point, grouping end-users accessing common wireless access points, and creating a vicinity-based community in real time allowing end-users accessing the public network service provider from the wireless access point to connect to other users in their vicinity. The apparatus includes means for carrying out the method described above.

In one embodiment, the method further includes determining physical location (street address or venue name) associated with the wireless access point from information received by the at least one end-user. Each end-user can provide the street address or venue name associated with the physical location of the hotspot after logging into the website hosted by the public network service provider.

In another embodiment, the vicinity-based community services include a barter and sale service. End-users at a particular wireless access point can exchange goods and services for other goods and services in kind.

In another embodiment, the vicinity-based community services include a lost and found service. End-users at a particular wireless access point can post, in real-time, lost or found items at the location of the wireless access point.

In yet another embodiment, the vicinity-based community services include and on-line game service. One or more end-users at the wireless access point can play the on-line games against each other.

In another embodiment, the vicinity-based community services comprise an advertising service. One or more advertising entities can bid to provide advertising to the end users at a given wireless hotspot based upon the user traffic patterns at that hotspot (e.g. number of users at a peak usage hour at a hot spot) or other end-user profiling characteristics such as age, gender etc.

In yet another embodiment, the vicinity-based community services include a service for receiving bids to advertise at a particular physical location in real time. The bidding entity associated with the highest bid is selected, and advertisements associated with the selected entity are provided in real time to the location.

### BRIEF DESCRIPTION OF THE DRAWINGS

FIG. 1 is block diagram of a communications network including a wireless hotspot for enabling a plurality of mobile devices to access a public network via an access point;

FIG. 2 is block diagram of a network including a wireless hotspot for enabling a plurality of mobile devices to access a public network via an access point in accordance with the principles of the present invention;

FIG. 3 is a flow diagram for a method for creating a mesh network of WiFi hotspots and enabling vicinity based networks in accordance with the principles of the present invention;

FIG. 4 illustrates a graphical user interface of a home webpage for logging into a service provider for providing services in accordance with the principles of the present invention;

FIG. 5 illustrates a graphical user interface of a webpage for registering as a member of the service provider of FIG. 4;

FIG. 6 illustrates a graphical user interface of a webpage for creating and identifying a mesh network of user hotspot locations affiliated with the service provider of FIG. 4;

FIG. 7 illustrates a graphical user interface of a webpage for participating in a chat room with other members of the service provider of FIG. 4;

FIG. 8 illustrates a graphical user interface of a webpage for posting goods and services available for exchange with members of the service provider of FIG. 4;

FIG. 9 illustrates a graphical user interface of a webpage for sharing files with members of the service provider of FIG. 4;

FIG. 10 illustrates a graphical user interface of a webpage for posting blogs to members of the service provider of FIG. 4;

FIG. 11 illustrates a graphical user interface of a webpage for posting other information for members of the service provider of FIG. 4;

FIG. 12 illustrates a graphical user interface of a webpage for posting lost and found items with the service provider of FIG. 4;

FIG. 13 illustrates a graphical user interface of a webpage for providing a search function;

FIG. 14 is a graphical representation illustrating the number of users logged on at particular times of a day;

FIG. 15 is a graphical representation illustrating the gender of users logged on at particular times of a day;

FIG. 16 is a graphical representation illustrating the number of users logged on at different hotspot locations;

FIG. 17 is a graphical representation illustrating the distribution of users as categorized by age;

FIG. 18 is a graphical representation illustrating the traffic sorted by device type for users logged on at particular times of the day;

FIG. 19 is a graphical representation illustrating the average time spent by users for each service offered by the service provider of FIG. 4;

FIG. 20 is a flow diagram of a method for participating in a barter service in accordance with the principles of the present invention;

FIG. 21 is flow diagram of method of providing advertising to a hotspot in accordance with the principles of the present invention;

FIG. 22 is a flow diagram of a method for acquiring profiling information of the users of the service provider; and

FIG. 23 is a flow diagram of a method of playing a game at a hotspot in accordance with the principles of the present invention.

To facilitate understanding of the invention, the same reference numerals have been used when appropriate, to designate the same or similar elements that are common to the figures. Unless stated otherwise, the drawings shown and discussed in the figures are not drawn to scale, but are shown for illustrative purposes only.

### DETAILED DESCRIPTION OF THE PREFERRED EMBODIMENTS

The present invention provides a method and apparatus that takes advantage of new trends in the consumer technology area. One trend is the rising popularity and availability of wireless technologies such as WiFi technology particularly in public settings in metropolitan locations. Public deployment of WiFi networks have skyrocketed in parks, cafes, bookstores, airports and college campuses. There are proposals being considered to roll-out city-wide WiFi service in various large metropolitan cities. Another trend is the popularity of social networking sites, such as “MySpace.com”, “Facebook.com” and the like, which allow users to form online communities. The present invention includes various applications that utilize WiFi capabilities to create vicinity-based user groups.

In particular, the present invention is directed to a method and apparatus for creating vicinity-based communities over the Internet by a vicinity-based community service provider (VCSP) for wireless mobile devices of end-users that have accessed the VCSP via a wireless access point at a wireless hotspot. A vicinity-based community service is a service provided by the VCSP which discovers (i.e., identifies) and connects wireless users within physical vicinity of each other at a WiFi hotspot. Once a “vicinity-based community” at a physical location (i.e., a hotspot) is created, the users can potentially interact physically or non-physically with each other. The VSCP identifies a group of users at a wireless hotspot based upon their common public IP address and interconnects them, thereby creating a vicinity-based user group. The VSCP may also request the street address or the venue name of the hotspot from the end user in order to correlate the vicinity-based group to a specific geographical location.

For example, end-users connected to a hotspot provided by a coffee shop (e.g., STARBUCKS), illustratively located at 100 Madison Avenue, NY, N.Y., are asked to provide the street address of the STARBUCKS where the WiFi hotspot is located. End users are also asked other optional data such as age and gender etc. of each user. As the public IP addresses of each hotspot are unique, the VCSP is able to build a database that associates the unique public IP addresses of each hotspot with the street address of a physical location (e.g. “280 Park Ave, NY, N.Y.” or “Starbucks at 48th and Park, NY, N.Y.”).

Once the end-users at a particular access point log into the website of the VCSP, they are able to view other members of the VCSP who have also logged in from the same access point associated with a particular wireless hotspot. The VCSP can offer a variety of services to the logged-in end users, all of whom now form the vicinity-based community at the wireless access point.

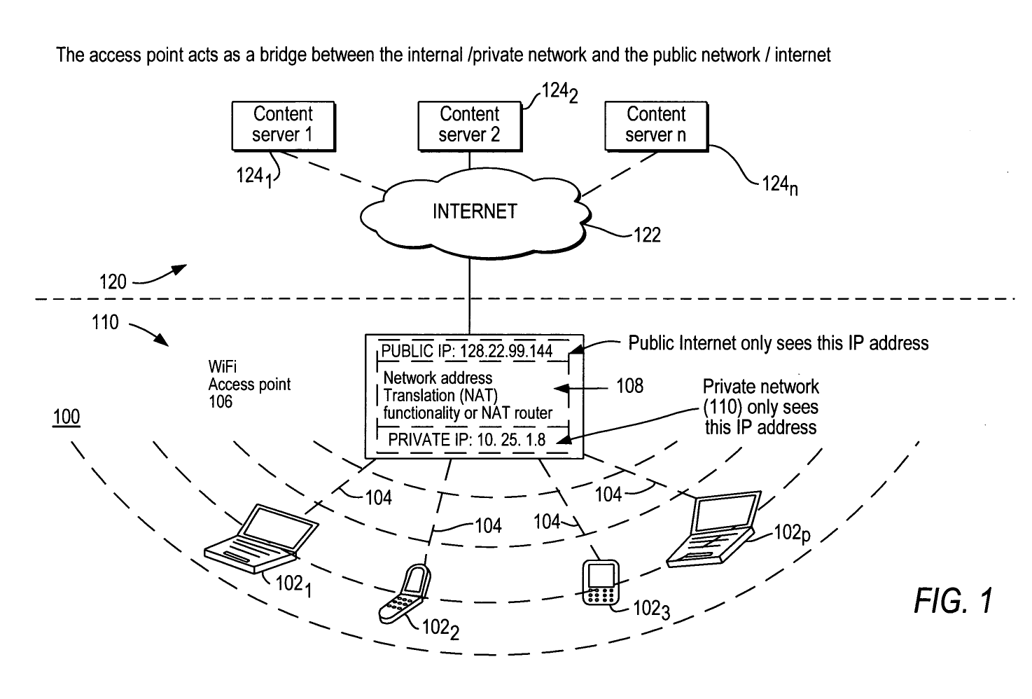

Reference will now be made to the preferred embodiments of the invention, examples of which are illustrated in the accompanying drawings FIGS. 1-23. An exemplary embodiment of a communications network 100 is shown in FIG. 1, and is designated generally throughout by reference numeral 100.

Referring to FIG. 1, a block diagram is shown illustrating how one or more mobile devices 102 at a public WiFi hotspot 110 interact with the public network 120. In particular, a communications network 100 includes a public WiFi hotspot 110 communicably coupled to a public network 120 via an access point 106. The public network 120 includes, for example, content servers 124₁, through 124ₚ (collectively content servers 124) that store and/or host information (e.g., multimedia information and data), illustratively, from websites, and are communicably linked together to form the public internet 122.

The WiFi hotspot 110 enables at least one mobile device (e.g., a plurality of mobile devices 102₁ through 102ₚ, collectively mobile devices 102), such as a laptop computer, PDA, and the like, to communicate (e.g., exchange information) with each other over a local private network 104, as well as to communicate with the content servers 124 over the Internet 122 via the access point 106. Thus, the mobile devices 102 at the hotspot 110 form a local network 104 with the access point 106. The access point 106 includes a network address translation device 108, and provides network address translations (NAT). The mobile devices 102 form a “local network” 104 with the access point 106, while everything outside of (i.e., external to) the hotspot 110, i.e., all servers & computers residing on the public Internet, is considered the “public” network 120.

The access point 106 utilizes a unique “public” IP address (e.g., 126.22.99.144 illustratively shown in FIG. 1) which relays data between the wireless mobile devices 102 connected to the wireless network 104 and the external or public network, such as the Internet 122. An IP address is necessary because all data communications takes place in form of data packets. Each packet must contain the IP address of the source device and the IP address of the destination device.

Whenever a mobile device 102 that is connected to a hotspot 110 requests information from the public network (e.g., the Internet) 120, the mobile device 120 sends data packets containing a “local” IP address to the access point 106. All devices on the internal network 104 use local IP addresses (these local IP addresses are not visible to the public networks). On the other hand, the access point 106 interacts with the public network 120 with a public IP address, which is visible to all devices on the public internet 122.

The access point 106 (which includes the NAT router 108) replaces the “local” IP address with its own “public” IP address, and forwards the packets to the destination device (e.g., content server) on the Internet or external network 120. When the public network 120 sends packetized information back to the requesting mobile device 102, the NAT router 108 replaces the “public” IP address with the mobile device's “local” IP address, and routs the packetized information to the requesting mobile device 102.

Accordingly, an access point 106 at a WiFi hotspot 110 conceals internal IP addresses from the public internet 122, and the only IP address visible to the public network 120 is the unique IP address of the access point 106. Thus, only a single, unique IP address (belonging to the access point) will represent an entire group of mobile devices to the public network(s), and the access point 106 acts as an interpreter between the two networks. That is, the access point 106 acts as a bridge between the public network (i.e. internet or any other networks outside the hotspot) 120 and the hotspot's internal network 104.

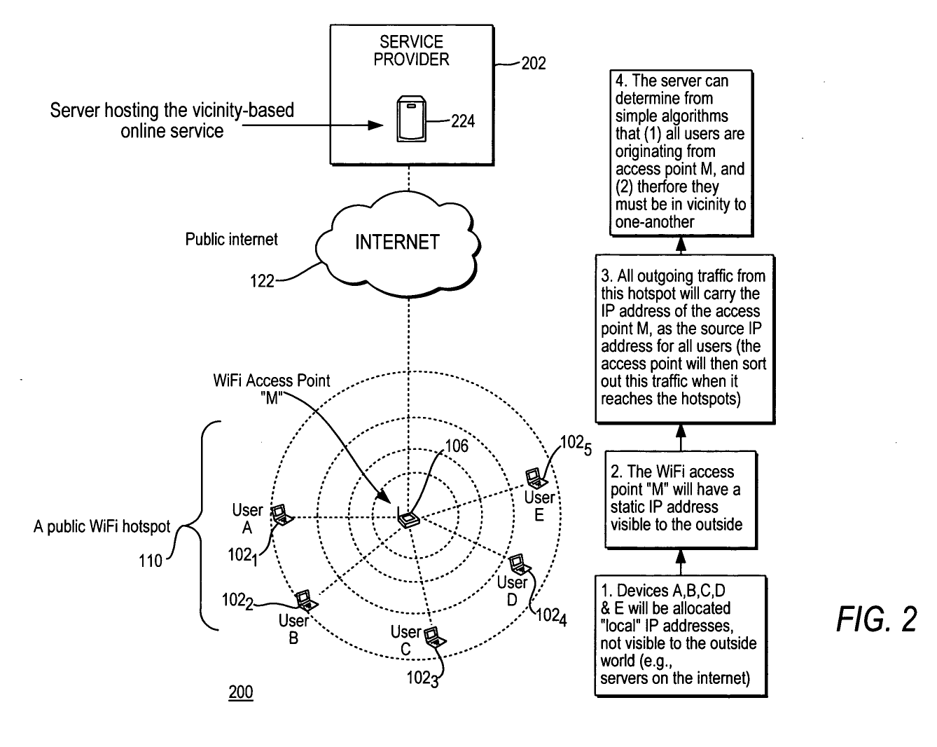

An exemplary embodiment of a communications network 200 of the present invention is shown in FIG. 2, and is designated generally throughout by reference numeral 200.

Referring now to FIG. 2, a communications network 200 includes a public WiFi hotspot 110 coupled to the public Internet 122 in a conventional manner. Illustratively, mobile devices 102₁ through 102₅ are connected via wireless communications to Internet via the access point 106, as discussed above with respect to FIG. 1. The access point (which includes the NAT router 108) allocates “local” IP addresses to the mobile devices (e.g., laptops, PDA, and the like). The local IP addresses of the mobile devices 102 are not visible to network environments external to the hotspot 110.

The WiFi access point 106 has a static IP address that is visible to communication networks external to the hotspot 110. The NAT router 108 at the access point 106 replaces the IP address of the source mobile device with the IP address of the access point in a well known manner. As such, all outgoing traffic from the hotspot 110 carry the IP address of the access point 106 as the source IP address for all users.

Similarly, all incoming traffic to the devices 102 connected to the hotspot 110 carry the IP address of the access point 106 as the destination IP address for all users. The NAT router 108 at the access point 106 replaces the IP address of the access point with the local IP address of the destination mobile device in a well known manner.

The network 200 of FIG. 2 further includes a vicinity-based community service provider (VCSP) 202 having at least one content server 224 coupled to the Internet 122 in a conventional manner. The server 224 includes at least one processor, memory and support circuitry for running programs that, for example, identify users that are originating from a particular access point 106 and then groups those users having a common IP address to the same hotspot 110. Accordingly, since each hotspot 110 has a unique static IP address, and the range of wireless communications for any given hotspot is limited, any users accessing the hotspot are deemed to be in vicinity of each other. For example, any users of mobile devices accessing a hotspot 110 illustratively provided by a public library are deemed to be, and are in fact, in vicinity to each other.

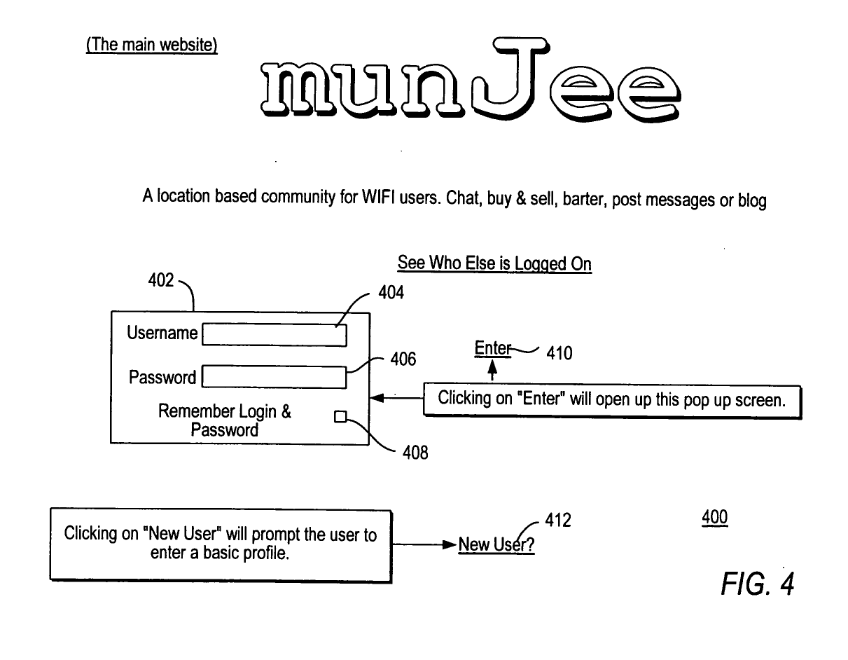

The at least one server 224 further includes programs and data for hosting a website of the VCSP 202. For example, the server 224 provides web pages for user access to information, as well as interactive and non-interactive services. The server 224 is also capable of storing information that is entered on the web pages or uploaded by the users, among other functions and services, as discussed below in further detail with respect to FIGS. 4-23.

Accordingly, the present invention includes an online service that facilitates a website which enables users at a WiFi hotspot to discover other users connected to the same hotspot, thus forming a vicinity-based community. Once the users log into the website of the online service provider 202, the users can engage in various activities with other users in their vicinity (i.e., physical location), such as providing bartering services for goods and services among wireless users in a vicinity; providing vicinity-based targeted advertising; creating a bidding system for advertisers; enabling WiFi users in the vicinity to play video games with one-another, providing chat rooms, among other activities and services. Thus, the present invention enables the creation of location-based and vicinity-based communities.

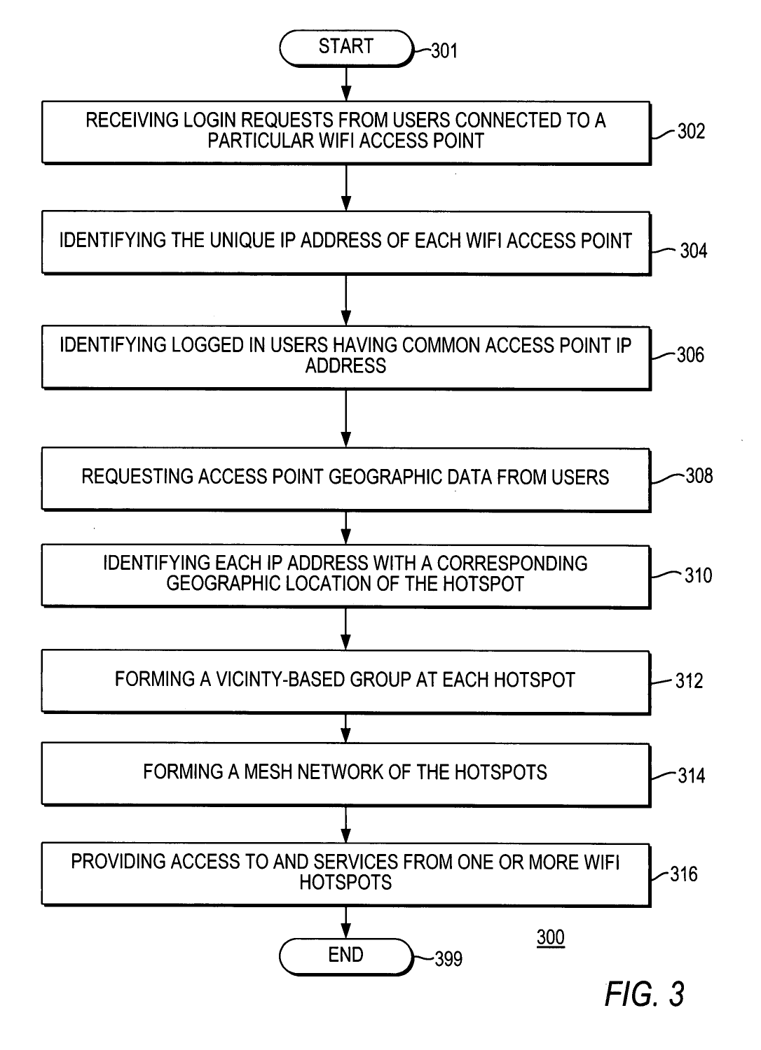

Referring now to FIG. 3, the flow diagram provides an illustrative embodiment of a method 300 for forming WiFi hotspot based mesh networks. The method 300 starts at step 301, where at least one user located at each of one or more hotspots have established wireless connectivity with the Internet. That is, the users at each hotspot are provided with Internet connectivity via an associated access point 106 as discussed above. At step 302, the at least one server 224 of the VCSP 202 receives a login request from a user that is connected to a particular WiFi access point (hotspot).

At step 304, the at least one server 224 identifies the unique IP address of each WiFi access point. At step 306, the server 224 identifies all the users who have logged in from a common hot spot as having the same access point IP address.

At step 308, the server 224 requests the user to provide geographical information (e.g., street address or venue name) corresponding to the hotspot 110 from which they are accessing the Internet 122. For example, the users can illustratively enter into a field located on a web page “650 5th Avenue, NY, N.Y.” or “NY Public Library, 5^{th} Avenue, New York, N.Y.” This location information provides an alternative use of the IP address of a particular hotspot, and can be used to attract users to engage in services and promotions at particular hotspot locations.

At step 310, the server correlates the geographic locations of the hotspots to their unique IP addresses. In this manner, the VCSP 202 can determine the locations and geographical distributions of hotspots in a particular region. For example, in a five-block radius in a particular metropolitan city, there may be a dozen hotspots that are available for users to access the Internet. Such information can be utilized by the VCSP 202 to provide particular services to users accessing a particular hotspot 110. For example, the owner of a music store who has logged in to the VCSP 202 can choose to advertise discount coupons to other users logged on the hotspots in his store's vicinity. As will be discussed below in further detail, other services can be provided to users at particular hotspots 110.

At step 312, the server 224 forms a vicinity-based user group at each hotspot 110. A vicinity-based user group allows the VCSP 202 to provide services to the member users of the group. In particular, when a user at a hotspot logs into the website of the VCSP 202, the user automatically becomes part of the vicinity-based user group. The user can then access various web pages from the VCSP website to participate or receive particular service offered by the VCSP 202. The services include receiving particular advertisements, a goods and services exchange program, sharing of files (e.g., music) as permissible under law, a chat room, a message board for blogs and the like, among other services, as discussed below with respect to FIGS. 4-23. Thus, users accessing a hotspot and who have logged into the website of the VCSP 202 can receive and participate in the services offered by the VCSP 202, as well as communicate with each other (e.g., chat room).

At step 314, the server 224 forms a mesh network of the WiFi hotspots. In particular, the server connects other similar hotspots (i.e. hotspots where users have logged onto the VCSP website) to one another, thereby creating a mesh network of WiFi hotspots. At step 316, the server enables users to access and receive services from one or more WiFi hotspots. That is, the VCSP 202 creates a vicinity-based user network by creating WiFi-hotspot based mesh networks. In this manner, WiFi users at one hotspot can be linked to users at other hotspots, thereby allowing them to browse through the list of available WiFi hotspots on the VCSP network and log on to other hotspots. The method 300 then proceeds to step 399, where method 300 ends.

The vicinity-based user network (i.e., the mesh-network of vicinity-based hotspots 110) increases the VCSP services that are available to the users at the hotspots. For example, the location based barter service provides the users with the ability to barter products in their local vicinity-based hotspot community, as well as with users in the entire vicinity based online community (i.e., mesh network). Similarly, vicinity-based advertising provides the ability to advertise to an audience at a particular WiFi hotspot based upon the profile (e.g., age or gender) of the user (among other profile information), as well as advertise to other vicinity-based hotspots in the mesh network of the VCSP 202.

Further, a bidding system for advertisers provides the ability to create a bidding system for advertisers, thus enabling the advertisers to bid for rights to advertise at a prime hotspot for a particular time of the day for a particular audience either at one or more vicinity-based hotspots in the mesh network of the VCSP 202. Alternatively, a location based video gaming service enables users to play video games with others in their vicinity or with users located in other vicinity-based hotspots.

The server 224 of the VCSP 202 includes programming which determines that WiFi mobile devices accessing a single hotspot are connected to the same WiFi access point, and therefore must be in close vicinity to one-another. Accordingly, all devices 102 originating from the same WiFi access point are clustered in the same vicinity-based group.

Additionally, all WiFi users who are logged on to the server 224 of the VCSP 202 are requested to input the local street address or the venue name of the hotspot from where they are accessing the public network (e.g. “650 5th Avenue, NY, N.Y.” or “Starbucks at 48th and Park, NY”). In this manner, the VCSP 202 can tag (i.e., correlate) the IP address of each WiFi hotspot with a physical address. Since the IP addresses of WiFi hotspots are mostly static IP addresses, the VCSP 202 can maintain a database of WiFi access point IP addresses with their corresponding physical addresses (i.e. the street address, city, state & zip code). Therefore, the VCSP 202 can maintain a database of IP addresses of public WiFi hotspots with corresponding geographical addresses. For example, if a WiFi access point IP address is 254.243.56.33, a user that enters the address for the hotspot as 270 Park Avenue, NY, such address can be added to a designated database field associated with this IP address. Therefore, the next time a user logs in to the website from that specific IP address, the VCSP 202 can correlate this specific IP address with the address.

The VCSP 202 can provide visual interfaces to users, where they can tag, locate, and sort through physical addresses in their local vicinity, or surf to other geographical areas and connect with users, and surf their local areas. That is, the VCSP 202 can connect some or all local hotspots together to form a mesh network of WiFi hotspots, which are geographically spread, for example, over an entire metropolitan area, a state or the country. Advantageously, a vicinity based network of users can receive services from the VCSP via their respective access point (node) on the mesh network. Moreover, the users can hop from one node (e.g. a user at WiFi hotspot located at a first hotspot, such as 100 Park Avenue, NY) to another node (e.g., a second WiFi hotspot located at Times Square, NY).

For example, a user may find that the user activity at their current hotspot (e.g., the first hotspot of 270 Park Avenue) is slow, while the hotspot at the second hotspot (e.g., Times Square, NY) has many more users participating. The user can then link (i.e., hop) to the second hotspot location.

FIGS. 4-23 illustrate various web pages from the website provided by the VCSP 202 over the public network (i.e., Internet). The vicinity-based users accessing the hotspots can log into the home page of the website to participate in or receive various services from the VCSP at their local hotspot or at other hotspots forming the mesh network.

Referring to FIG. 4, the home page 400 of the VCSP website is shown. The home page 400 allows a registered user to login or a new user to register and then log in for accessing the VCSP website and services. The home page 400 includes a first window 402 having a usemame field 404 and password field 406 for entering the registered user name and password of the person logging in. The user name can be any name the user desires to either identify the user or provide anonymity. The password can by any string of characters, as conventionally known in the art. A check field 408 is provided for optionally remembering the user name and user password. Once the user enters the proper user name and password and selects (e.g., by clicking with a mouse) the “Enter” link 410, the user can access other pages of the VCSP website.

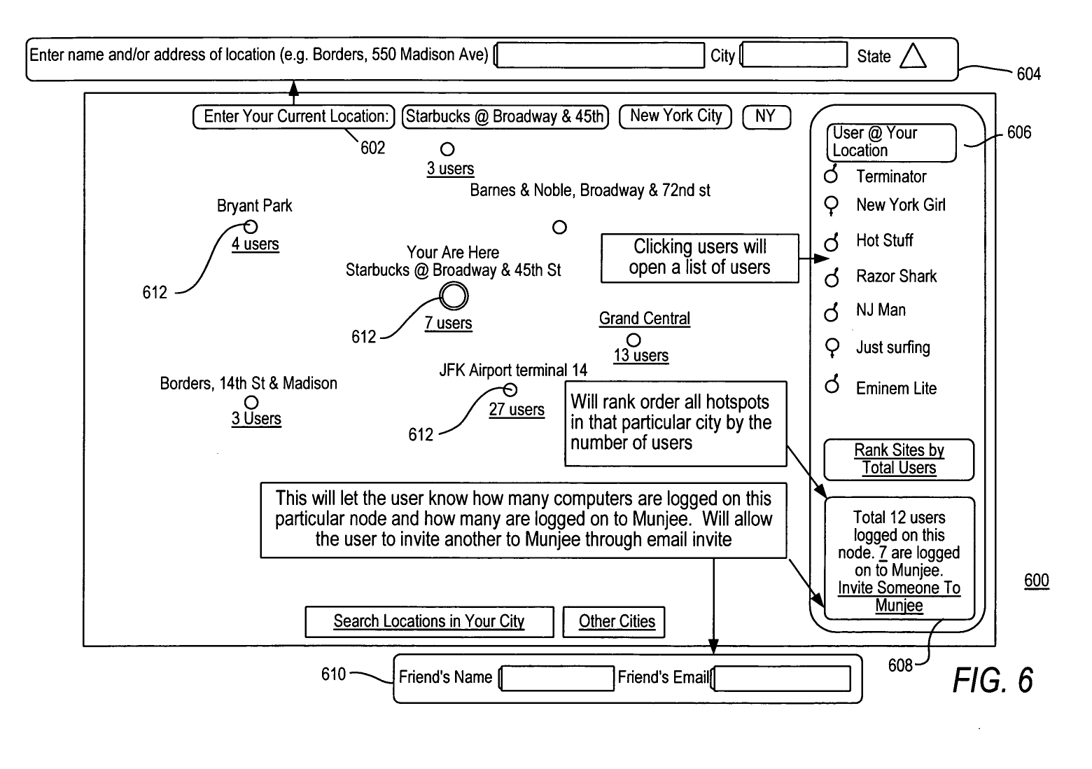

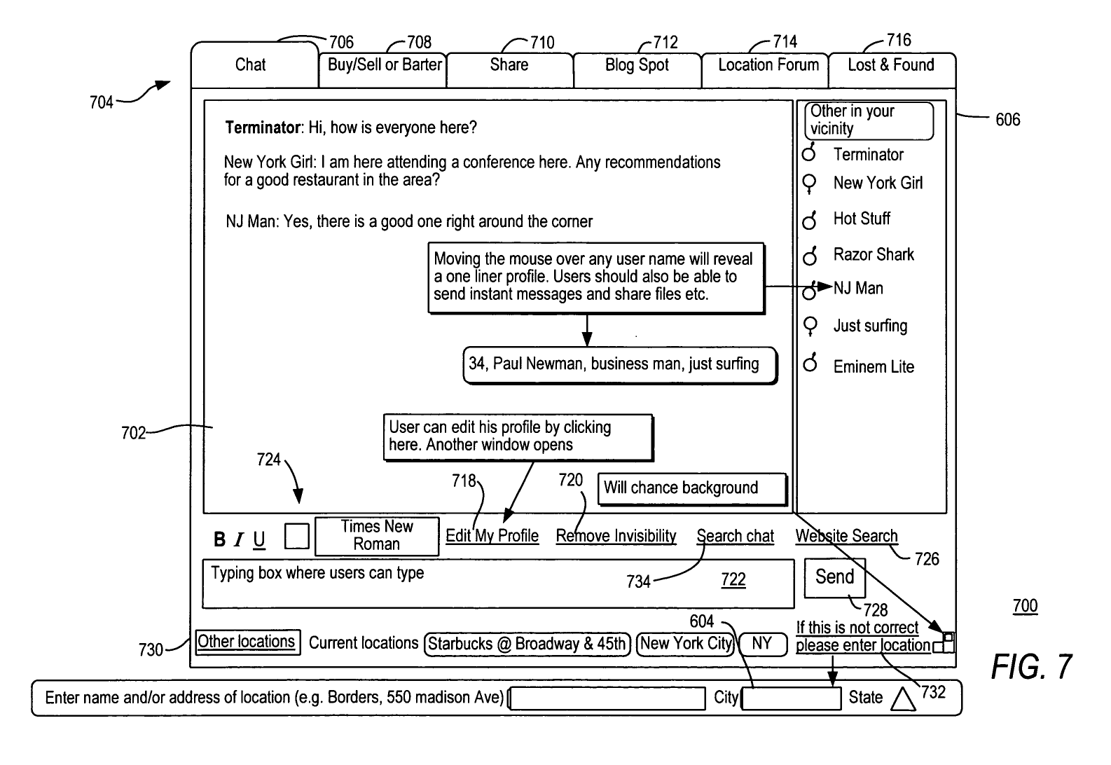

The home page also includes a link 414 to see who else is logged in. By selecting link 414, a list of users logged on to the website from the present vicinity-based hotspot is provided, as illustrated, for example, in the web pages of FIGS. 6 and 7.

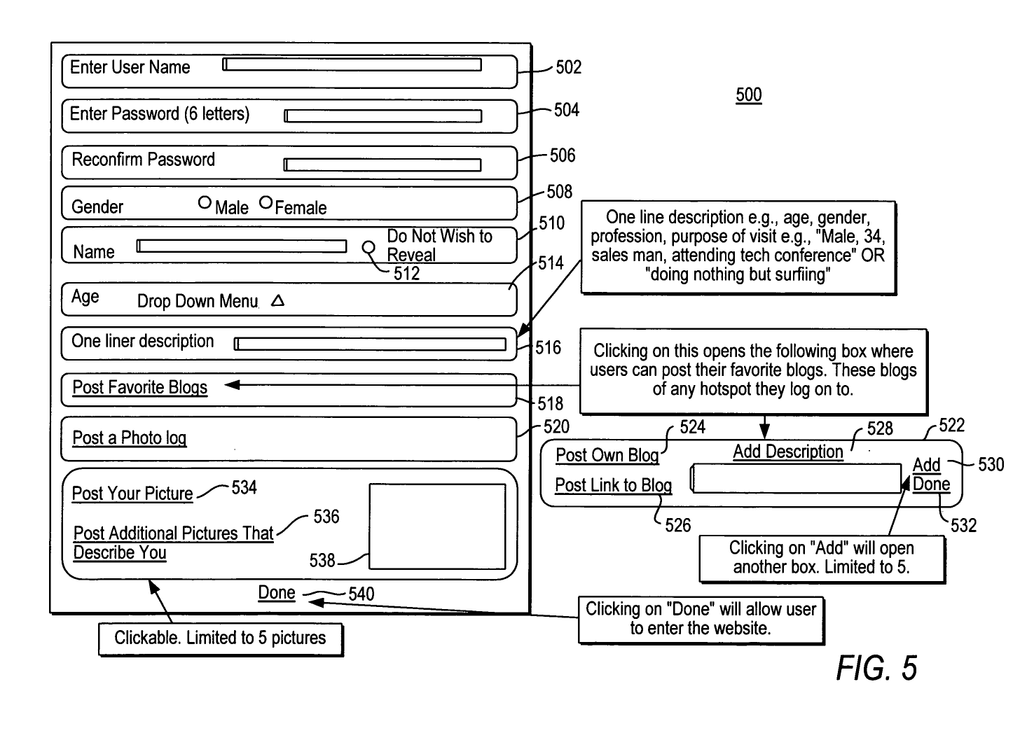

If the user is a new user, i.e., not registered on the VCSP website, then the user can select (e.g., point and click on) the “new user” link 412, which allows the user to enter registration information, as shown in FIG. 5. Referring to FIG. 5, the user must complete the registration form 500, which includes a plurality of fields for receiving appropriate registration and demographic type information. For example, the illustrative registration form includes an “Enter User Name” field 502, “Enter Password” field 504, “Confirm Password” filed 506, “Gender” field 508, “Actual User Name field 510, “Do Not Reveal Actual User Name” check box field 512, “Age” field 514, “One Liner Description of the User” field 518, “Post Favorite Blogs” field 518, “Post a Photo Log” field 520, and a “Post your Picture” field 534.

In one embodiment, all of the fields must be completed to register on the VCSP website. Preferably, some or most of the entry fields are optional, such that only the user name field 502 and password related fields 504 and 506 are mandatory for registration.

In one embodiment, selecting the “Post Favorite Blogs” field 518 opens a secondary blog window 522, which allows the user to select an option to post their own blog 524, post a link to a blog 526, add a description to a blog 528, and add another blog 530, which can be limited to a predetermined maximum number of blogs (e.g., five blogs). When the posting of a blog is complete, the user selects the “Done” link 532 to store the blog information and close the secondary blog window 522.

If the user wishes to post a picture, the user is given the option to select a link 536 to add additional pictures. In one embodiment, the number of pictures that can be added is limited to a predetermined number, and the uploaded pictures can be viewed in a picture window 538.

As described above, once a user registers on the web page illustrated in FIG. 5, and then logs into the VCSP website on the home page as illustrated in FIG. 4, the server 224 presents the web page illustrated in FIG. 6 to the user on his/her mobile device 102.

Referring to FIG. 6, a graphical representation of a mesh network of hotspots is shown. The webpage 600 illustrates how mesh-networks that include various hot spots are created and identified from the information receive by the users. The web page 600 includes an “Enter Current Location” field 602, which upon selection, provides a pop-up window 604 that allows the user to enter the location of the hotspot, such as the street address, city and state.

The web page 600 also displays a list 606 of other users at the present hotspot 110. In one embodiment, the list includes the user names associated with users that have logged into the VCSP website. In another embodiment, the list 606 includes the total number of mobile devices having wireless connectivity at the present hotspot 110. Optionally, a link 608 is provided to invite other others at the hotspot 110 to join the VCSP website. If link 608 is selected, then a pop-up window 610 will be displayed to allow the user to invite another user to the VCSP website by entering the invitee's name or email address.

In one embodiment, the web page 600 also displays the present hotspot, as well as other hotspots that are proximately located to the user's present hotspot. The other hotspots are labeled by their physical addresses (as opposed to their static IP addresses) and can include the number of users presently logged into the VCSP website. The number of additional hotspots displayed is a matter of design choice based on the number of hotspots proximate the user's current hotspot, the number of users logged into the VCSP website, among other factors. In one embodiment, the hotspots are illustrated with symbols (e.g., circles) 612 that can be selected to access various services that are available by the VCSP 202, as discussed below with respect to FIGS. 7-13.

For example, another hotspot may be labeled “JFK Airport, NY—Terminal 4” and indicate that 27 users are logged into the VCSP website. If the user clicks on a “users” link for such hotspot, then a list of those users will be displayed. Alternatively, if the user selects the link 612 associated with the present hotspot or another hotspot, the user is presented with the illustrative web page 700 shown in FIG. 7.

The illustrative web page 700 allows the user to select various services that are available exclusively through the VCSP website. The webpage 700 includes a main window 702 having a plurality of tabbed headers 704 that are labeled with a description of the available services by the VCSP 202. For example, in one embodiment, the tab headers 704 include tabs for a chat room (e.g., “Chat”) 706, “Buy/Sell or barter” 708, “Share” 710, “Blog Spot” 712, “Location Forum” 714 and “Lost & Found” 716. The number and types of services described herein is not to be considered as being limiting.

In FIG. 7, the Chat tab 706 is shown as being selected (highlighted), and displaying a text conversation between two or more users. In one embodiment, the list 606 of users at the present hotspot is shown on the right side of the display screen. In another embodiment, the user can select another user shown in the list 606 by illustratively moving the mouse pointer over the username to display the one liner profile that such user had entered during the registration process, as described with respect to FIG. 5.

The illustrative web page 700 also provides a link 718 to allow the user to edit their profile. A link 720 can also be provided to remove their concealment (i.e., invisibility) to other users.

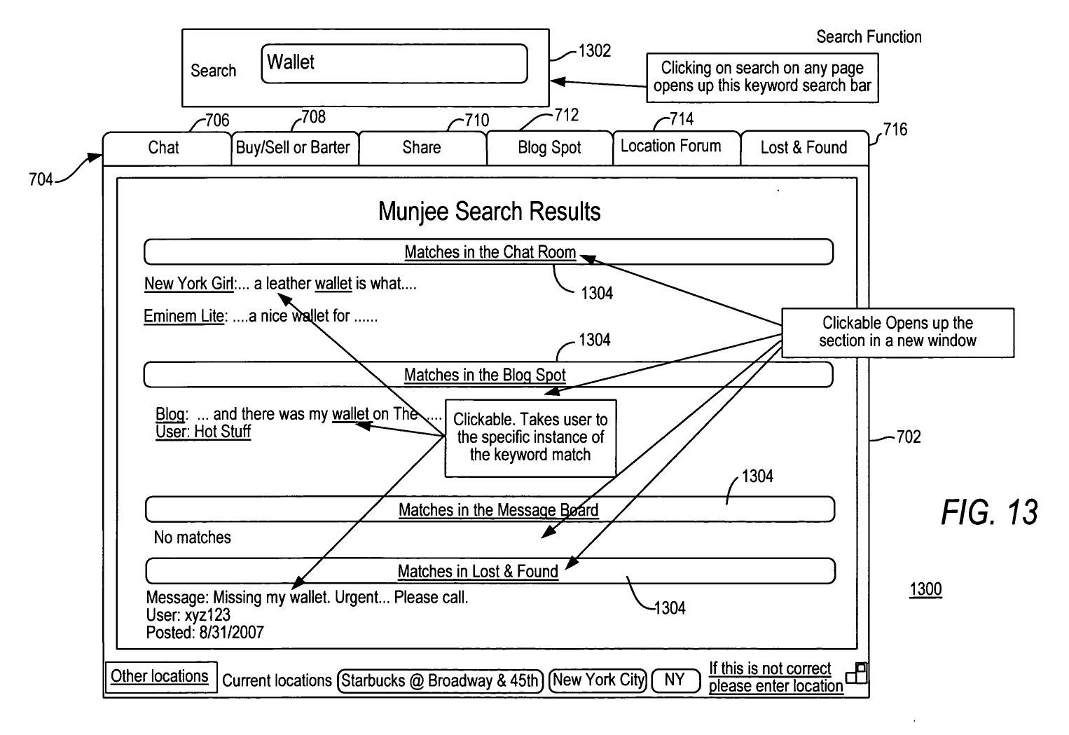

A text box 722 is provided to allow the user to enter text or characters to conduct the chat with other users. A send button 728 sends the text message for display in a well known manner. Various text formatting buttons 724 can be provided, such as “Bold,” “Italic,” font type, among others to enhance the enjoyment of the chat room. A website search link 726 provides access to search the VCSP website for particular words or subject matter that are either provided by the VSCP 202 or posted by the users, as described below in further detail with respect to FIG. 13. Alternatively, the search can be limited to the chat service webpage 700 by selecting the “Search Chat” link 734.

A link 730 can be provided to access other hotspot locations. Selecting the link 730 displays the chat room of the selected hotspot location.

The web page 700 displays the current location, and includes a link 732 to change the present location if the displayed location is not correct. If link 732 is selected, then pop-up window 604 is displayed, and the user can enter the correct location information.

As described above, in one embodiment, the VCSP services include a “bartering” or “for sale” service, which allows the users to post on the VCSP's website, various goods or services that one end-user is offering in exchange for either goods and services in kind or cash payment with another end-user. Once goods or services are posted as being offered for sale, the other end-users in the vicinity-based community can bid on the posted item.

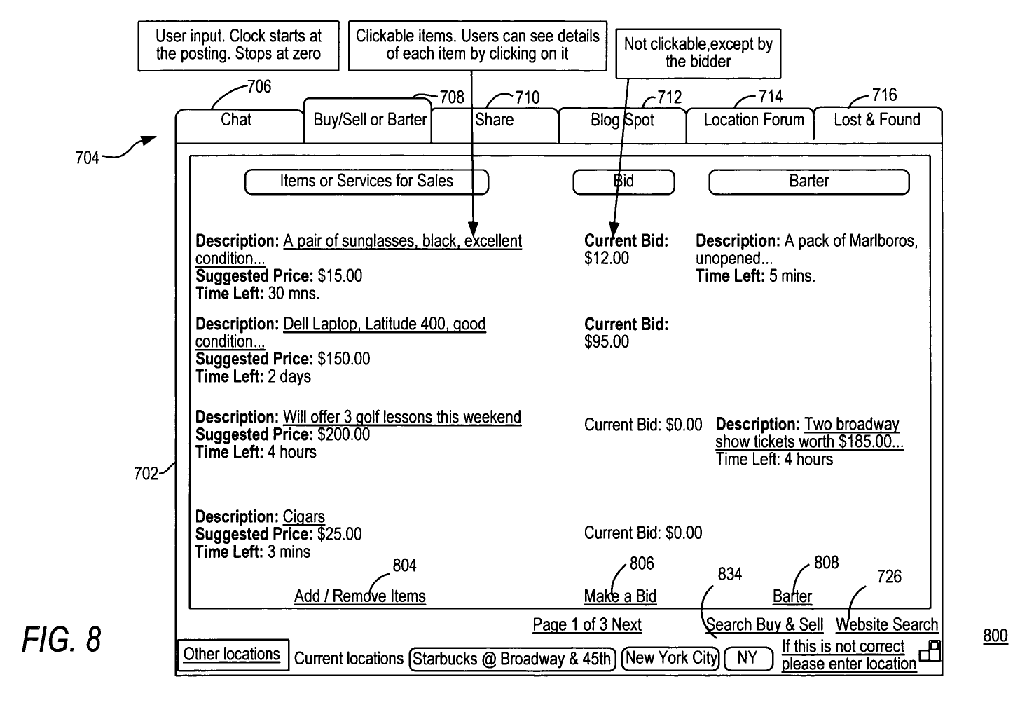

Referring to FIG. 8, an illustrative webpage 800 is provided to the user when the “Buy/Sell or Barter” tab 708 is selected. The web page is substantially the same as shown in FIG. 7, and includes the main screen 702 and the tab headers 704. The buy/sell or barter web page 800 further includes a link 804 to add/remove items, a link 806 to make a bid, and a link 808 to barter. For example, end-user “A” posts a pair of sunglasses for sale. Other end-users can bid on this item by posting cash bids or the exchange of other goods or services (e.g., a carton of Marlboro cigarettes). The end-user offering the item for sale can then select the winner, and contact the winning end-user to exchange either the goods or services (or cash) and finalize the sale.

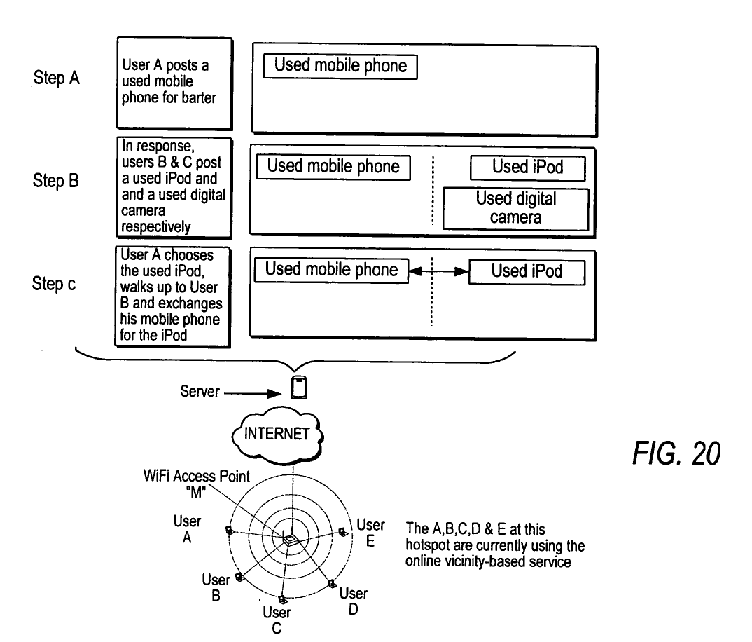

Referring now to FIG. 20, the VCSP 202 can enable users to barter products and services with other users in their vicinity. Essentially, all users logged on to the website service through a public WiFi hotspot can publish (on the VCSP website) items available for barter, which will be visible to other users at that hotspot 110. Since these users are all in the vicinity of the hotspot, they can walk up to other users and exchange any items that they are interested in.

For example, mobile devices A, B, C, D and E have logged onto the vicinity-based service hosted on a server. The mobile devices A, B, C, D, & E are identified by the VCSP vicinity-based service to be in proximity to one another. These mobile devices are visible to one another on the web site, thus forming a vicinity-based network. A user of device A can then declare an item or service available for barter to other users in the hotspot (i.e., vicinity). This particular item or service then becomes visible to other users who then may post any items or services for bartering with user A. Any additional users entering this WiFi communication network and logging on to the vicinity-based service are also able to view and post any items/services for exchange.

The vicinity-based service also enables the mobile devices to communicate with each other within the same vicinity without declaring the content of its message to other users. In this manner, the seller of an item or service can selectively share information with potential buyers.

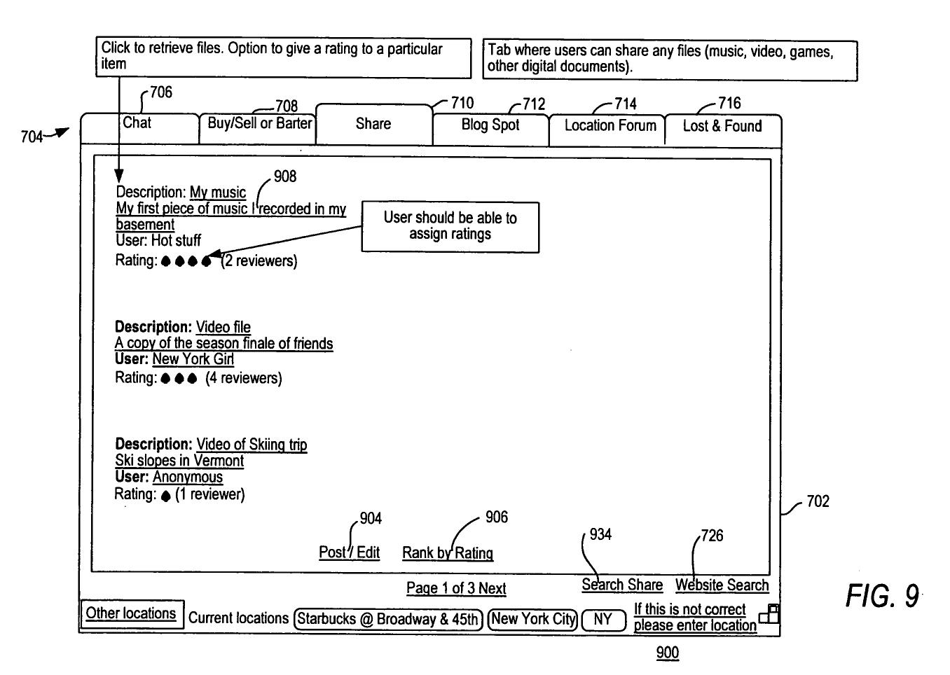

Referring now to FIG. 9, in yet another embodiment, an illustrative webpage 900 is provided to the user when the “Share” tab 710 is selected. The display screen of the web page is substantially the same as shown in FIG. 7, and includes the main screen 702 and the tab headers 704. The share web page 900 further includes a link 904 to post/edit shared items, and a link 906 to assign ratings to the posted shared item. In one embodiment, the share service 900 allows the users to upload files, such as music files on the VCSP's website, add a brief description of the music, and receive commentary from other users regarding their perceptions of the music after listening to it. Once the music files have been uploaded to the VCSP 202, the other end-users in the vicinity-based community can listen to the music by selecting the music link 908, and rate the music, illustratively by assigning 1-5 stars to the music. For example, end-user “Hot Stuff” posts her music she recorded in her basement, and provides a brief description. Other end-users can download and assign a rating to the music. The display screen shows the number of other users who rated the music and the average rating.

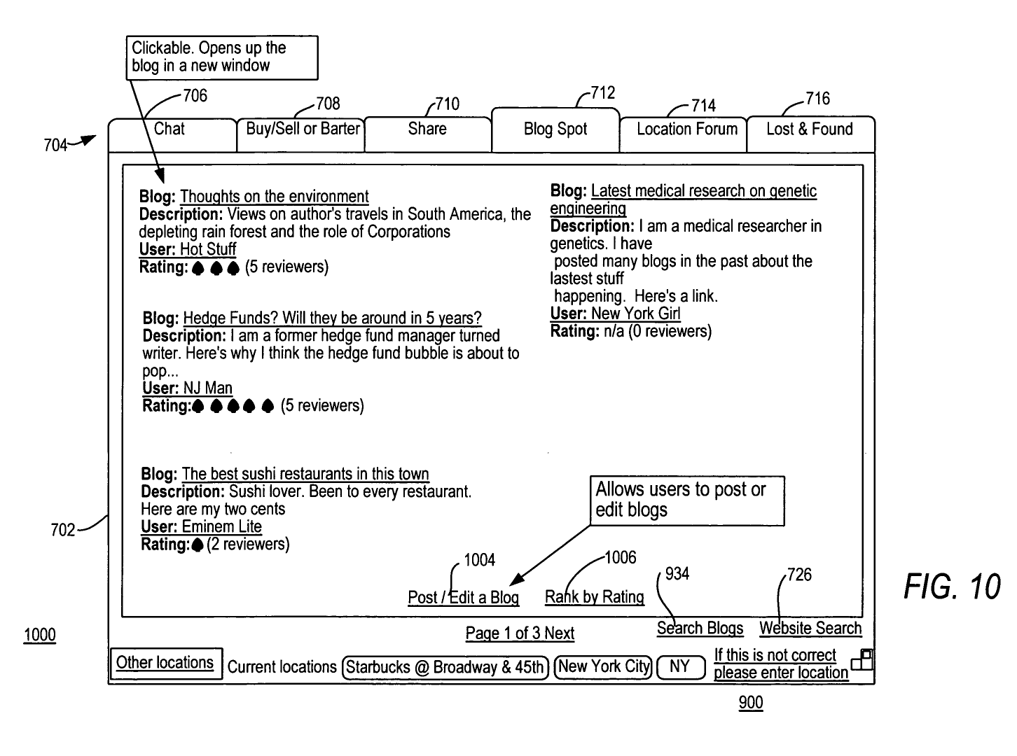

Referring now to FIG. 10, in yet another embodiment, an illustrative webpage 1000 is provided to the user when the “Blog Spot” tab 712 is selected. The display screen of the web page is substantially the same as shown in FIG. 7, and includes the main screen 702 and the tab headers 704. The blog web page 1000 further includes a link 1004 to post/edit blog items, and a link 1006 to assign ratings to the posted blog item. The blog service 1000 allows the users to post blogs regarding any subject matter on the VCSP's website, add a brief description to blog, and receive commentary from other users regarding the posted blogs. That is, the other end-users in the vicinity-based community can read the blog by selecting the blog link 1008 and rate the blog, illustratively by assigning 1-5 stars to the blog. For example, end-user “Hot Stuff” posts her blog regarding her thoughts on the environment, and provides a brief description. Other end-users can review the blog and assign a rating to it. The display screen shows the number of other users who rated the blog and the average rating.

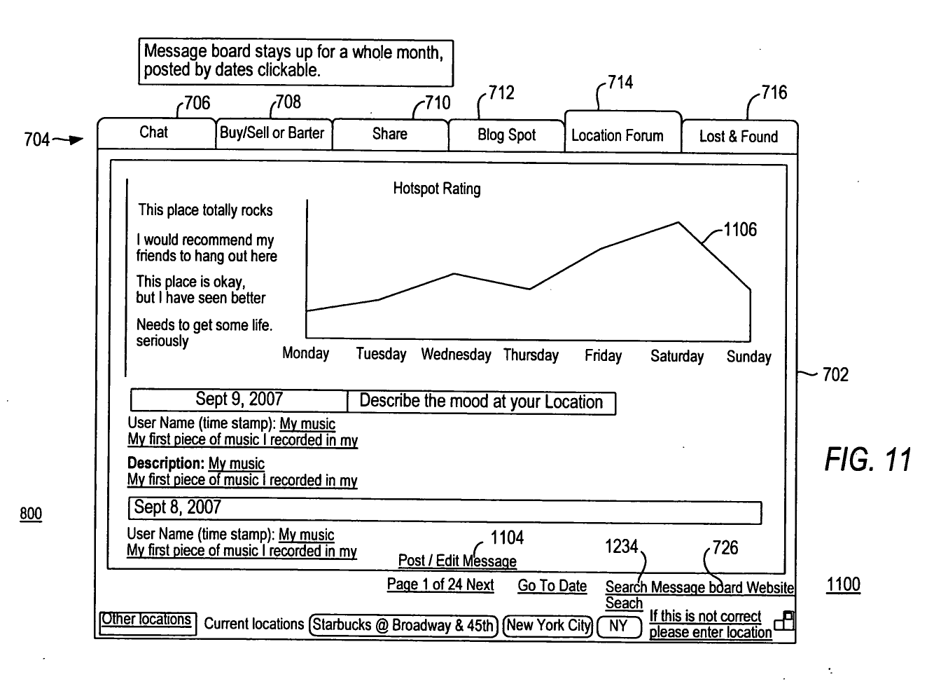

Referring now to FIG. 11, in another embodiment, an illustrative webpage 1100 is provided to the user when the “Location Forum” tab 714 is selected. The display screen of the web page is substantially the same as shown in FIG. 7, and includes the main screen 702 and the tab headers 704. The location forum web page 1100 further includes a link 1104 to post or edit a message. The location forum service 1100 allows the users to post information associated with describing or defining a mood of the hotspot location. For example, an end-user can provide input for a chart or graphic display 1106, which can reflect individualized or collective mood on a particular day. In this manner, for example, users can browse through ratings of hotspots and determine which hotspots can be a better place for social gatherings on particular days versus other days.

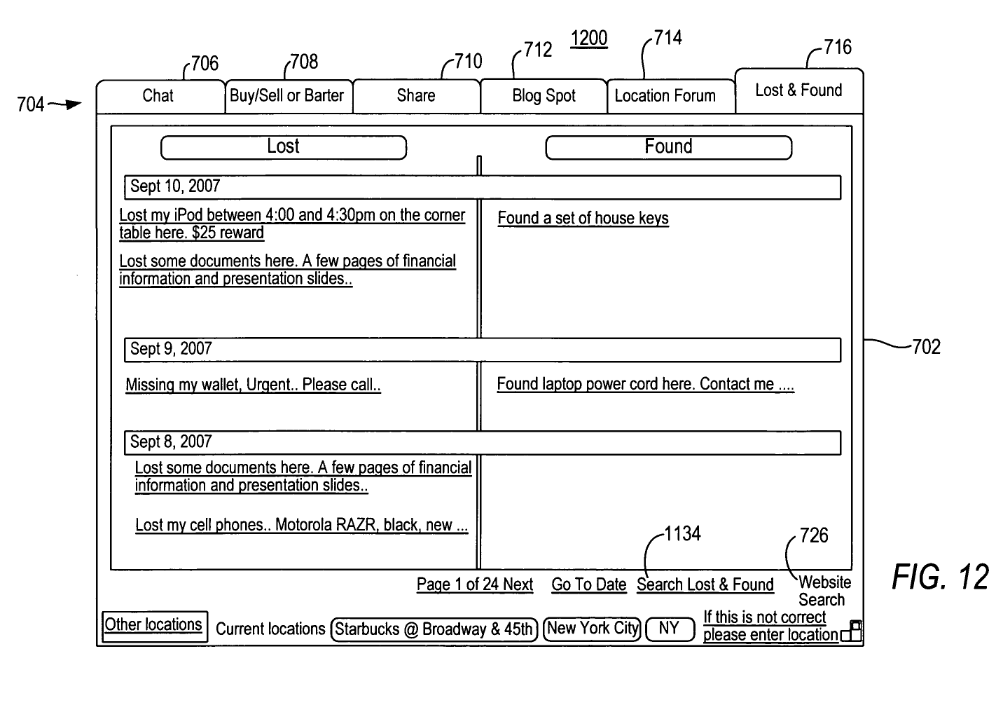

Referring to FIG. 12, an illustrative webpage 1200 is provided to the user when the “Lost & Found” tab 716 is selected. The display screen of the web page is substantially the same as shown in FIG. 7, and includes the main screen 702 and the tab headers 704. In one embodiment, the lost & found web page 1200 is divided into two columns such that lost items are posted in one column, while found items are posted in the other column. In particular, the end-users in the vicinity-based community can post lost and/or found items on a particular date for a specific geographical location (e.g., a wallet lost at a wireless hotspot at a local café). The VCSP 202 maintains the posting of the lost and found items for a predetermined period (e.g., 3 months). Each time an end-user logs into the VCSP's website from the access point 106, they can check to see if another end-user has found a lost item or is claiming a found item. Targeted advertising at wireless hotspots using vicinity-based networks The vicinity-based service permits advertisers to target particular geographical locations. Advantageously, the advertisers can target the audience of a particular hotspot according to the profile, e.g., age/gender etc. of the users and/or a particular time of the day. As users register online on the VCSP website, profile information about our users, such as age, gender, occupation, interests and the like are requested during the registration process and securely stored by the VCSP 202. Advertisers can selectively choose to advertise to users at a particular address, city, state or zip code. Similarly advertisers can target the traffic patterns at a particular geographic location according to the time of the day.

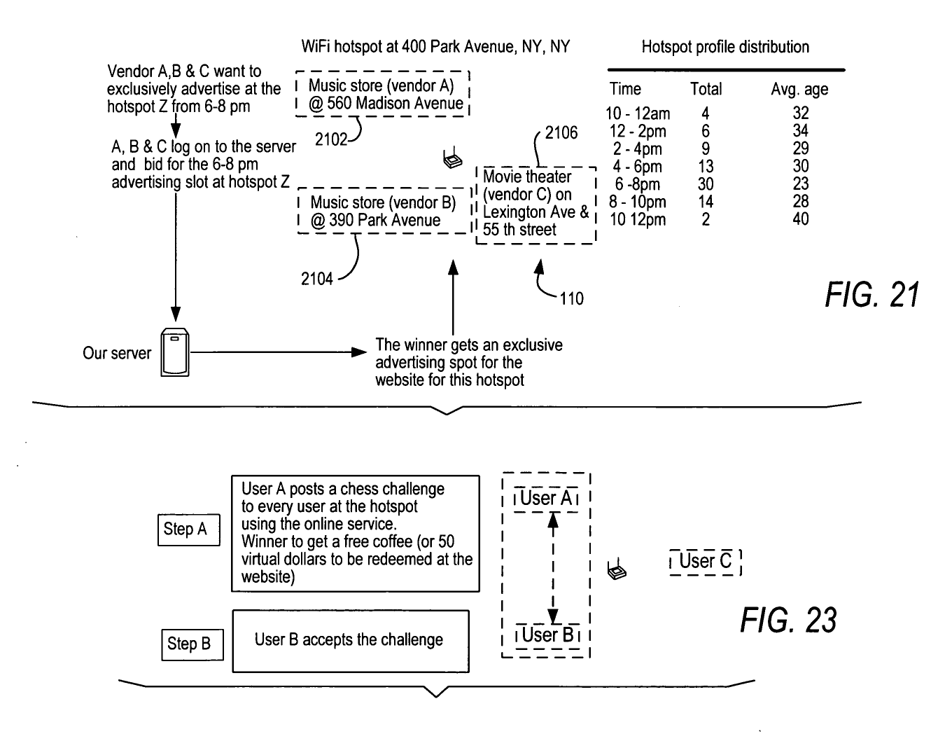

Referring to FIG. 21, an illustrative flow diagram is shown for providing advertisements to a particular hotspot 110. By illustration, a particular hotspot 110 has a music shop “A” 2102 in its neighborhood. This hotspot's average user age is around 30 but drops to 23 between 6 and 8 pm. The owners of the music shop “A” 2102 believe that the under 25 age groups represents the appropriate age for its ideal customers and therefore chooses to advertise from 6-8 pm on the hotspot offering special discount coupons. Accordingly, the music shop “A” 2102 can potentially lure walk-in customers.

The VCSP 202 can also provide an option to the advertisers to restrict their ads only to individuals under/over a certain age, or of a certain gender at a particular geographical area. For example, the music store 2102 can have the option of having their advertisements delivered to male users with ages of 25 or less in their neighborhood.

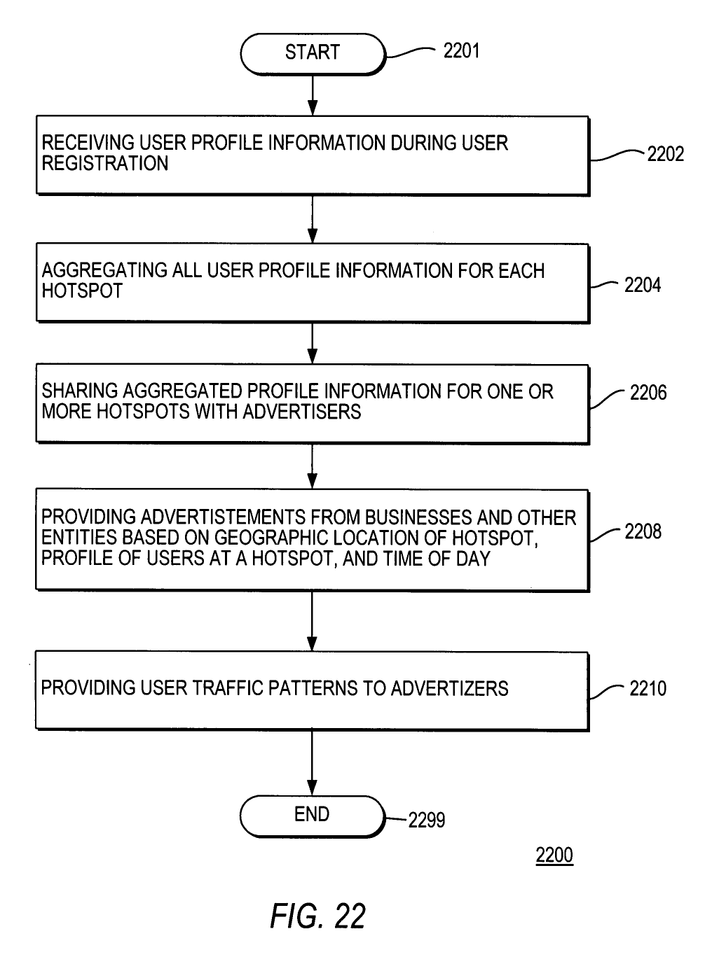

FIG. 22 is a flow diagram of a method 2200 for acquiring information of the users of the VCSP. The method 2200 starts at step 2201 and proceeds to step 2202, where the VCSP receives user information during user registration. For example, each user enters age and gender information, among other information in their profiles at the time of registration.

At step 2204, the VCSP 202 aggregates all user information for each hotspots. At a given time the VCSP can determine the ages and gender distributions of all users present a particular hotspot.

At step 2206, the VCSP can share the user information with advertisers (on an anonymous basis). That is, the VCSP can tell the advertisers how many users are present at a particular time, the gender distribution (i.e., percent male/female) and their average ages. This information will vary at different times of the day, as users having different ages and genders will log off or join the hotspot throughout the day.

At step 2208, the VCSP provides advertisements from advertisers (e.g., local businesses or other entities). In particular, businesses or other entities can advertise online through the VCSP website for a particular hotspot based upon the (i) geographical location of the users, (ii) profile (age/gender) of the users at the hotspot (iii) time of the day.

At step 2210, the VCSP can also provide user traffic patterns to print or bill board advertisers in the neighborhood who can selectively use our information to tailor their land-based advertisement at a particular time of the day.

For example, the wireless access provider (e.g., STARBUCKS) can advertise to the vicinity based community (e.g., special coupons for coffee), thus making sure that it can advertise to potential customers within walking distance or even sitting wireless access provider (i.e., hotspot host). Alternatively, advertisers that are not associated with the wireless access provider and/or the VCSP can send or post advertisements to the end-users in the vicinity-based community based on the end-user's profiles. The method 2200 then proceeds to step 2299 where the method ends.

In one embodiment, multiple advertisers can bid against each other to have their advertisements displayed at a particular location and time of day, or based on some other end-user profile.

Referring again to FIG. 21, the local music store “A” 2102 wants to target younger audience for its online advertisements, as described above. Additionally, local music store “B” 2104 and a local movie theatre 2106 also want to target younger audience between 6-8 pm. The VCSP can create a bidding system for such advertisers who may want to pay a premium for rights to advertise at a given time of the day, such as prime time.

Through the VCSP, the advertisers can select individual hotspots or hotspots in a particular city or particular zip code. The advertisers can view the traffic patterns, for example, the age/gender distribution for particular geographical locations, and then select the time during which they want their advertisements to appear to users. An advertiser can then log on to the VCSP website and bid against other advertisers for rights. The winner of the bidding contest receives exclusive rights to advertise on the VCSP website for the selected hotspot at a particular time of day, for example, between 6-8 pm to female end-users who are 18-25 years old at a particular geographical location.

In another embodiment, real-time advertising is provided at one or more physical locations (e.g., billboard at Times Square, NY) based on real-time bidding between advertising entities. In particular, advertisement entities, e.g., businesses competing for the right to exclusively advertise in real-time at a particular location, send bids to the VCSP for such rights. The winner of the bidding can then advertise, for example, on the billboard at Times Square in real time, for a predetermined time period (e.g., 1 hour).

For example, if advertisers competing for business from young adults between the age of 21 and 27 at Times Square, multiple advertisers could compete by bidding against each other for the right to advertise in real time on one of the billboards for an hour duration, illustratively between 8-9 pm.

Referring now to FIG. 23, in another embodiment, the VCSP can provide on-line gaming to the vicinity-based community members. The VCSP can store numerous video games on their servers to form a library of games for selection by the end-users. The end users can then challenge one or more other members in the vicinity-based community to a game. The vicinity-based community of players is differentiated from other online communities of video game players in the sense that in a vicinity-based community, all the players are within physical proximity to each other. In an alternate embodiment, games can be played between wireless access points at different locations. Thus, the vicinity-based communities can be expanded to include other end-users who have logged into the website of the VCSP from other hotspots.

In one embodiment, the users can play video games with other users in the vicinity and offer prizes or virtual money for winners. In particular, the vicinity-based service enables users at a hotspot to play video games with one another, such that the users will be able to challenge one another and use virtual money or items such as a cup of coffee etc. as winning prizes.

For example, in FIG. 23, users A, B & C at a WiFi hotspot have logged on to the VCSP website. User A wishes to play chess with someone at the hotspot and sends a chess challenge to all online users at the hotspot. User A also sets up a free cup of coffee as a winning prize. User B accepts the challenge by responding to User A through our website, for example, the chat room.

The games can be played by two or more users at a WiFi hotspot. Other games can include tournaments in which players at a hotspot can team up and play with/against players at other hotspots.

Referring now to FIG. 13, in yet another embodiment, an illustrative search webpage 1300 can be displayed to the user when the “search website” link 726 is selected. The display screen of the web page 1300 is substantially the same as shown in FIGS. 7-12, and includes the main screen 702 and the tab headers 704. The search web page 1300 includes a keyword search bar 1302 which allows the user to enter in a string of characters to be searched on the VCSP's website.

For example, as shown in FIG. 13, the word “wallet” is entered into the search bar 1302. Upon selecting the “enter” or “go” button (not shown) each incident of the word “wallet” that exists on the website is displayed. In one embodiment, the webpage 1300 is divided into categories having headers 1304 identifying the various services provided by the VCSP 202. The headers are labeled, for example, “Matches in the Chat Room”, “Matches in the Blog Spot”, “Matches in the Message Board”, “Matches in Lost & Found”, and so forth. Each service category includes each instance of the word being searched (e.g., “wallet” and associated text with the searched word) or states that no match was found.

The headers 1304 also serve as links to their respective service. That is, the user can select or click on, for example, the “Matches in the Blog Spot” to go to the Blog Spot service 712 and the specific instance of the keyword match. In this manner, a user who loses for example, their wallet, can employ the search webpage 1300 and perform a search across the entire website for a particular term, without having to go through each service separately.

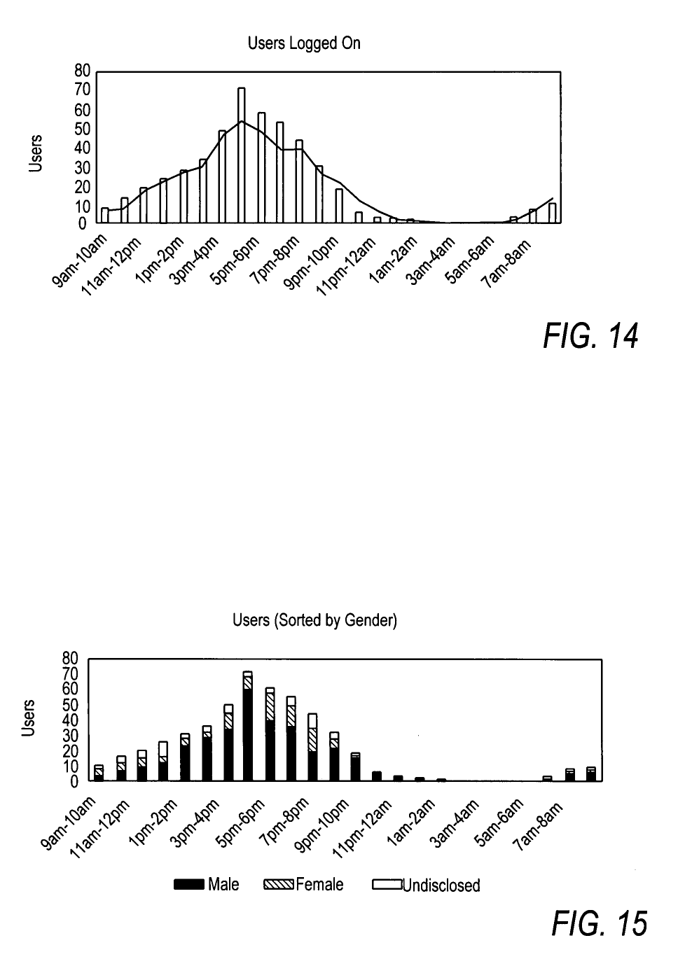

FIGS. 14-19 illustrate statistical information tracked by the VCSP to better assist in providing services to the users. Referring to FIG. 14, the chart illustrates that the average number of users logged into the VCSP website at particular times (hourly increments) of the day. The number of users is illustratively at the higher levels between 3:00 pm to 10:00 pm, with the peak number of users occurring approximately between 5:00 and 6:00 pm. The number of users logging in during the hourly time slots can be monitored on a daily, weekly, monthly or yearly basis, such that an average value is shown in the graph.

Referring now to FIG. 15, the illustrative graph depicts the number of users sorted by gender accessing the website during each hourly timeslot. Gender information is useful for advertisers who wish to target advertisements directed to either male or female genders.

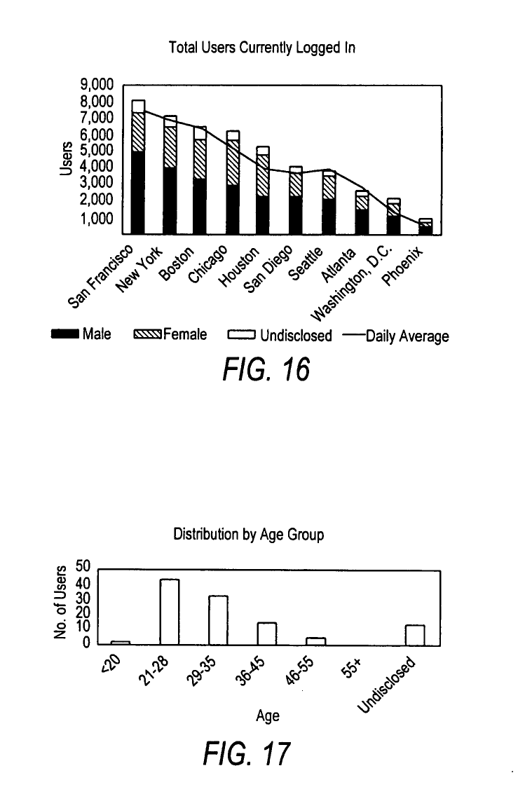

Referring now to FIG. 16, the illustrative graph depicts the number of users sorted by gender accessing the website from various metropolitan locations. For example, an aggregate of all users accessing the VCSP website from hotspots located in Seattle, New York, Houston, among other cities can be provided.

Referring now to FIG. 17, the illustrative graph depicts the number of users sorted by age groups. The distribution by age groups can be provided for a single hotspot or as an aggregate of numerous hotspots in a particular region.

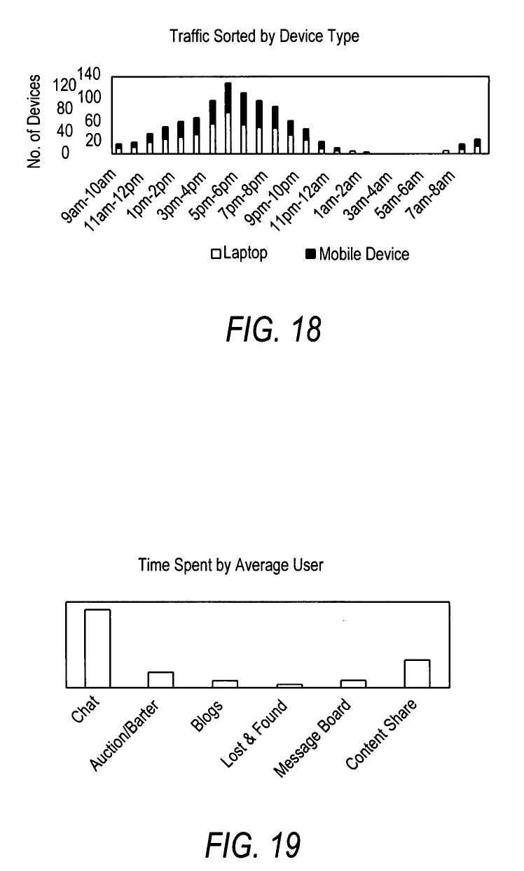

Referring now to FIG. 18, the illustrative graph depicts the traffic sorted by device type (e.g., laptop or other mobile device). The VCSP 202 can use this information to determine the preferred type of user mobile device at one or more hotspots, and such information can be helpful to the hotspot host to provide accommodations for particular types of mobile devices. For example, a laptop computer usually requires a desktop or other planar surface for the user to comfortably spend time surfing the Internet or enjoying the services provided by the VCSP.

Referring now to FIG. 19, the illustrative graph depicts the time spent by the average user in each of the VCSP's services. For example, approximately 50% of the average user's time is spent in the chat room, approximately 10% of the average user's time is spent in the buy/sell & barter service, and so forth.

The statistical information regarding user demographics and times of accessing the website can be important to the VCSP, the hotspot hosts, and advertisers who want to provide services and/or advertisements to particular users. For example, the VCSP can allocate additional bandwidth to handle the increased traffic loads during certain times of the day, and advertisers, such as the host of the hotspot or other advertisers, can post their advertisements based on the demographic profile information to attract more viewers of the advertisements.

The VCSP website of the present invention enables users at each WiFi hotspot to connect to other users connected to that hotspot. In this manner, the website enables the creation of “hotspot centric” communities. The VCSP website allows users to chat, buy and sell goods and/or services, and post messages.

Users logged into a particular hotspot can also access communities at other hotspots. In one embodiment, any “external” user accessing a particular hotspot is labeled as an outsider. That is, the location centric communities ensure that visiting hotspot users are distinguished from local hotspot users.

The website of the present invention is seamlessly accessible from most mobile devices, such as laptops and PDAs. Further, the website is scalable, such that hundreds or thousands of users can access the website without bandwidth constraints.

The chat-room service includes instant messaging, checking profiles, file transfers, among other features. All users who are logged on can see other users in the chat-room, unless a user options out from being visible to other users.

The Buy & Sell or Barter service allows users to post any item or service for sale. Alternatively, other users can post items and/or service for barter. In one embodiment, the items posted for sale, purchase or barter remain posted as long as the users are logged into the VCSP website. The items can remain posted for a predetermined time (e.g., 5 minutes) after the user has logged off to prevent accidental deletion of the item in the event of accidental failure of connectivity. The users can provide indication of whether they are actually present at the location hosting the sale or exchange of goods/services, or located and logged in from another location in the mesh network. The users can add descriptions and download pictures to best describe or show the item for sale.

The message board service allows users at a particular location (e.g., an airport) to post messages that will stay posted for that particular location for a time after the user has logged off. In one embodiment, the messages are sorted by date. In another embodiment, the last thirty days of messages are considered as “active”, while older messages are archived, but retrievable by clicking on a message archive link. Further, the users can post replies to the messages, such that a string of messages is generated.

The blog spot service allows users to post their blogs (or link to online blogs). In one embodiment, the blogs are considered “active” for seven days, and are sorted by date, while older blogs are archived and accessible by selecting a link to the archived blogs. Once a user logs onto a hotspot, the blogs automatically become part of a depository of blogs for that particular hotspot. Alternatively, users can post blogs at one or more non-local hotspots. In one embodiment, the photographic images that are downloaded can serve as blogs.

The lost and found service allows users to post lost and found items with respect to a particular location. Preferably, the posted item is active (remains posted) for seven days. Older postings can be archived for retrieval, for example, up to one year from the initial date of posting.

One of ordinary skill in the art will appreciate that the number of days an item is posted and then archived is a design choice for a particular VCSP service, and is not considered to be limiting.

Administrative controls include statistical information that can be used by the VCSP, the host of the hotspot, and advertisers, such that information can be directed to some or all of the users at one or more hotspots. Further, the statistical information can be made available to the users, such that the users can determine which of the hotspots they would like to interface with and receive services.

It will be apparent to those of ordinary skill in the art that various modifications and variations can be made to the present invention without departing from the spirit and scope of the invention. Thus, it is intended that the present invention cover the modifications and variations of this invention that come within the scope of the appended claims and their equivalents.

What is claimed is:

1. A method for providing vicinity-based community services at a wireless access location by a public network service provider, comprising the steps of:
receiving over a public network, at least one request for vicinity-based community services from at least one end-user accessing said wireless access point;
grouping end-users accessing common wireless access points; and
providing said vicinity-based community services in real time to end-users accessing said public network service provider from said wireless access point.

2. The method of claim 1 further comprising the step of determining a physical location associated with said wireless access point from information received by said at least one end-user.

3. The method of claim 2, wherein said determining a physical location comprises the steps of:
receiving physical address information of said wireless access location from each end-user; and
correlating said physical address information with an IP address associated with said wireless access location.

4. The method of claim 2, wherein said step of determining a physical location associated with said wireless access point comprises determining at least one of a street address and a venue name.

5. The method of claim 1, wherein said providing said vicinity-based community services comprises providing a barter service.

6. The method of claim 5, further comprising receiving from end-users at a particular wireless access point, postings of goods and services for exchange with other goods and services.

7. The method of claim 1, wherein said providing said vicinity-based community services comprises providing a lost and found service.

8. The method of claim 1, wherein said providing said vicinity-based community services comprises providing on-line games.

9. The method of claim 8, further comprising receiving from one or more end-users at said wireless access point, requests to play said on-line games.

10. The method of claim 9, wherein said requests to play said on-line games include requests for competitions with other end-users at said wireless access point.

11. The method of claim 1, wherein said providing said vicinity-based community services comprises providing an advertising service.

12. The method of claim 11, further comprising receiving from one or more advertising entities, bids to provide advertising to said at least one end-user based on end-user profiling.

13. The method of claim 1, wherein said providing said vicinity-based community services further comprises the steps of:
receiving bids to advertise at a particular physical location in real time;
selecting an entity associated with the highest bid; and
providing advertisements associated with said selected entity in real time to said location.

14. Apparatus for providing vicinity-based community services at a wireless access location by a public network service provider, comprising the steps of:
means for receiving over a public network, at least one request for vicinity-based community services from at least one end-user accessing said wireless access point;
means for grouping end-users accessing common wireless access points; and
means for providing said vicinity-based community services in real time to end-users accessing said public network service provider from said wireless access point.

15. The apparatus of claim 14 further comprising means for determining a physical location associated with said wireless access point from information received by said at least one end-user.

16. The apparatus of claim 15, wherein said means for determining a physical location comprises:
means for receiving physical address information of said wireless access location from each end-user; and
means for correlating said physical address information with an IP address associated with said wireless access location.

17. The apparatus of claim 14, wherein said means for providing said vicinity-based community services comprises providing a barter service.

18. The apparatus of claim 17, further comprising means for receiving from end-users at a particular wireless access point, postings of goods and services for exchange with other goods and services.

19. The apparatus of claim 14, wherein said means for providing said vicinity-based community services comprises providing a lost and found service.

20. The apparatus of claim 19, further comprising means for receiving from end-users at a particular wireless access point, postings of lost and found items at the location of the wireless access point.

21. The apparatus of claim 14, wherein said means for providing said vicinity-based community services comprises providing on-line games.

22. The apparatus of claim 21, further comprising means for receiving requests to play said on-line games from one or more end-users at said wireless access point,

23. The apparatus of claim 14, wherein said means for providing said vicinity-based community services comprises means for providing an advertising service.

24. The apparatus of claim 23, further comprising means for receiving from one or more advertising entities, bids to provide advertising to said at least one end-user based on end-user profiling.

25. The apparatus of claim 14, wherein said means for providing said vicinity-based community services further comprises:
means for receiving bids to advertise at a particular physical location in real time;
means for selecting an entity associated with the highest bid; and
means for providing advertisements associated with said selected entity in real time to said location.
